(19) United States
(12) Patent Application Publication
(10) Pub. No.: US 2007/0162632 A1
(43) Pub. Date: Jul. 12, 2007

(54) Apparatus and method for detecting and enabling video devices

(76) Inventors: Kay Ming Ng, Penang (MY); John P. Eley, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/479,054

(22) Filed: Jun. 30, 2006

(30) Foreign Application Priority Data
Dec. 28, 2005 (MY) PI20056219

(51) Int. Cl. G06F 3/00

(52) U.S. Cl. 710/15

(57) ABSTRACT

In some embodiments, a system board may include embedded graphics capability on the system board. An expansion slot on the system board may be adapted to receive an add-in card. A first circuit on the system board may detect the presence of a graphics card in the expansion slot automatically after powering up the system board. A second circuit on the system board may determine information associated with the graphics card automatically after powering up the system board. A third circuit on the system board may be configured to utilize the information associated with the graphics card to enable or disable all or some of the embedded graphics capability automatically after powering up the system board. Other embodiments are disclosed and claimed.

The invention relates to video devices. More particularly, some embodiments of the invention relate to add-in graphics cards and on board video devices.

### BACKGROUND AND RELATED ART

Some motherboards include embedded graphics. For example, graphics processing circuits and/or display driving circuits may be implemented on the motherboard. Such motherboards may further include expansion slots for add-in cards. For example, such add-in cards may include graphics cards.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a block diagram of an electronic apparatus according to some embodiments of the invention.

FIG. 2 is a block diagram of another electronic apparatus according to some embodiments of the invention.

FIG. 3 is a block diagram of another electronic apparatus according to some embodiments of the invention.

FIG. 4 is a schematic diagram of a logic circuit according to some embodiments of the invention.

FIG. 5 is a block diagram of another electronic apparatus according to some embodiments of the invention.

FIG. 6 is a block diagram of another electronic apparatus according to some embodiments of the invention.

FIG. 7 is a block diagram of another electronic apparatus according to some embodiments of the invention.

FIG. 8 is a block diagram of a switch according to some embodiments of the invention.

FIG. 9 is a block diagram of another switch according to some embodiments of the invention.

FIG. 10 is a block diagram of another electronic apparatus according to some embodiments of the invention.

FIG. 11 is a flow diagram in accordance with some embodiments of the invention.

FIG. 12 is a perspective view of an electronic system according to some embodiments of the invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

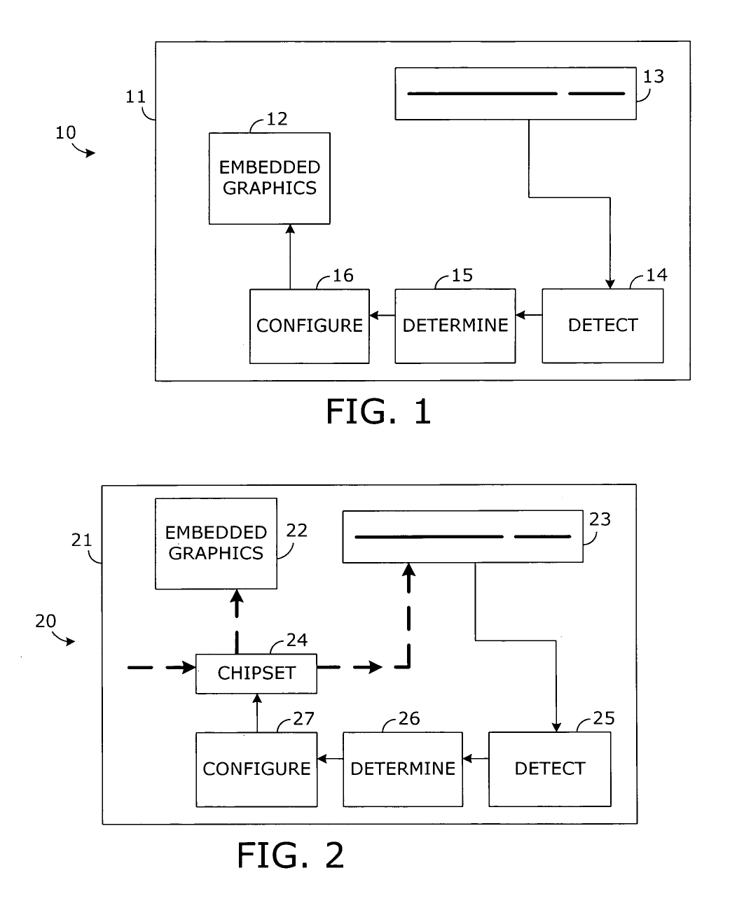

With reference to FIG. 1, an electronic apparatus 10 includes a system board 11 which may have embedded graphics capability 12 on the system board 11. An expansion slot 13 on the system board 11 may be adapted to receive an add-in card. A first circuit 14 on the system board 11 may detect the presence of a graphics card in the expansion slot 13 automatically after powering up the system board 11. A second circuit 15 on the system board 11 may determine information associated with the graphics card automatically after powering up the system board 11. A third circuit 16 on the system board 11 may be configured to utilize the information associated with the graphics card to enable or disable all or some of the embedded graphics capability 12 automatically after powering up the system board.

For example, the graphics card may include a digital video interface (DVI) capability. For example, the third circuit 16 may be configured to enable or disable an embedded digital video interface (DVI) capability. For example, the information associated with the graphics card may include a type of the graphics card.

In some embodiments of the present invention, the first circuit 14 may be configured to utilize a pull-up and/or pull-down strap arrangement on the graphics card to detect the presence of the graphics card in the expansion slot 12. The second circuit 15 may be configured to utilize the pull-up and/or pull-down strap arrangement on the graphics card to determine the information associated with the graphics card. For example, the information associated with the graphics card may include a type of the graphics card inserted in the expansion slot.

With reference to FIG. 2, an electronic apparatus 20 includes a system board 21 which may have embedded graphics capability 22 on the system board 21. An expansion slot 23 on the system board 21 may be adapted to receive an add-in card. A first circuit 24 on the system board 21 may detect the presence of a graphics card in the expansion slot 23 automatically after powering up the system board 21. A second circuit 25 on the system board 21 may determine information associated with the graphics card automatically after powering up the system board 21. A third circuit 26 on the system board 21 may be configured to utilize the information associated with the graphics card to enable or disable all or some of the embedded graphics capability 22 automatically after powering up the system board.

For example, the graphics card may include a digital video interface (DVI) capability. For example, the third circuit 26 may be configured to enable or disable an embedded digital video interface (DVI) capability. For example, the information associated with the graphics card may include a type of the graphics card.

In some embodiments of the present invention, the first circuit 24 may be configured to utilize a pull-up and/or pull-down strap arrangement on the graphics card to detect the presence of the graphics card in the expansion slot 22. The second circuit 25 may be configured to utilize the pull-up and/or pull-down strap arrangement on the graphics card to determine the information associated with the graphics card. For example, the information associated with the graphics card may include a type of the graphics card inserted in the expansion slot.

The apparatus 20 may further include a chipset 27 on the system board 21 for directing graphics signals. For example, the third circuit 26 may be configured to assert straps on the chipset 27, automatically after powering up the system board 21, to direct the graphics signals to either the embedded graphics 22 or the graphics card in accordance with the type of the graphics card inserted in the expansion slot 23.

Some embodiments of the present invention may relate to any board that implements embedded graphics (e.g. serial digital video output (SDVO)/DVI graphics) in addition to add in cards. For example, add in cards may include PCI Express (PCIe) graphics cards, Advanced Digital Display 2 (ADD2) graphics cards, and media expansion card (MEC) graphics cards.

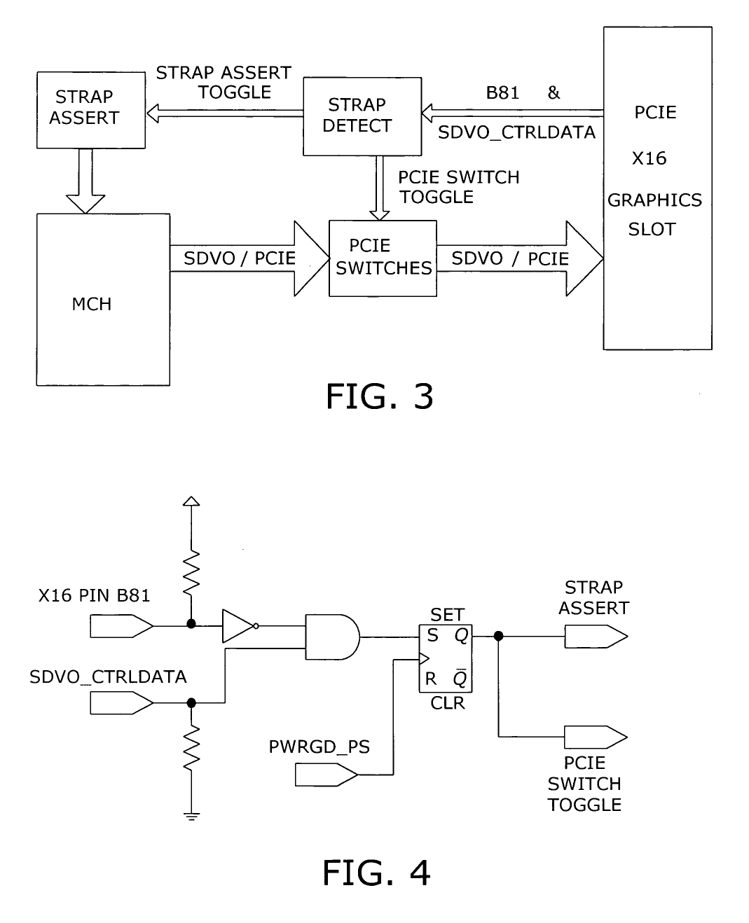

With reference to FIG. 3, some embodiments of the invention may include a system having embedded graphics (e.g. SDVO/DVI graphics capability) and an expansion slot adapted to receive an add-in card (e.g. an x16 PCIe graphics slot). The system may includes a first circuit on the system board to detect the presence of a graphics card in the slot (e.g. a strap detect circuit), and a second circuit to determine information associated with the graphics card (e.g. a strap assert circuit). A third circuit may utilize the information to enable or disable all or some of the on board graphics capability (e.g. a PCIe switch circuit).

For example, some embodiments of the invention may utilize the unique pull-up and pull-down straps particular to a graphics card to determine the presence of the card and the type of card inserted in the slot. Once determined, the circuit may assert the proper chipset straps (i.e. if needed) and redirect the necessary signals to either the on board graphics or the graphics card (e.g. from a memory controller hub (MCH) or graphics and memory controller hub (GMCH) to either the on board DVI or the card slot).

In FIG. 3, a strap detect circuit receives signals corresponding to the B81 and SDVO_CTRLDATA pins of a PCI Express x16 graphics slot. The strap detect circuit may determine if a card is in the slot and what type of card may be present in the slot. Depending on the type of card (and if a card is present), the strap detect circuit provides an appropriate signal to a strap assert circuit and sets appropriate PCIE switches for the video signals. The strap assert circuit asserts appropriate straps for the MCH for either embedded graphics or expansion graphics.

For example, some embodiments of the invention may detect the type of card installed in the slot in accordance with the state of three strap pins. Table 1 gives one example of how three strap pins may be utilized to determine a type of the graphics card in a PCI slot.

TABLE 1

| | X16 Pin B81 | SDVO_CTRLDATA | NOA_8 |
|---|---|---|---|
| No Card | Float | Low | Low |
| ADD2-N | Float | High | Low |
| MEC | Float | High | High |
| PEG | Low | Low | Low |

After determining what type of graphics card is inserted in the slot, a chipset strap may need to be asserted to enable or disable on board graphics. Table 2 is one example of how information determined from the three strap pins may be utilized to assert a strap signal to a chipset on the system board.

TABLE 2

| | X16 | | | |
|---|---|---|---|---|
| | Pin | | | Strap |
| | B81 | SDVO_CTRLDATA | PWRGD_PS | Assert |
| No Card | High | Low | Low to High | Low |
| ADD2-N/MEC | High | High | Low to High | High |
| PEG | Low | Low | X | High |

With reference to FIG. 4, the circuit has two basic choices: enable graphics installed on the board, or enable graphics installed via an add-in card. As such, only the strap signals B81 and SDVO_CTRLDATA are necessary to determine card presence. However, they do need to be asserted into determined states. Therefore B81 uses a weak pull up is used to provide a high state, and SDVO_CTRLDATA uses a weak pull down. They are then combined through gate logic (e.g. to implement the logic states of Table 2).

This result is latched into a flip flop. The flip flop output (see Table 2) toggles transistor circuits that assert the necessary straps to enable SDVO for the onboard DVI configuration. They also toggle the PCIe switches used to redirect the SDVO signal lines between the graphics slot and the down DVI transmitter.

The flip flop is latched by system power supply PWRGD. This is necessary because the straps are sampled by the MCH as its PWR_OK asserts. The required 100 ms (min) delay between the power supply PWRGD and the assertion of chipset PWR_OK provides ample time for the circuit to detect and assert the appropriate straps.

In conventional designs it may not be possible to implement both onboard (down) DVI and also support add in cards (or certain types of add-in cards). For example, the conventional system may support on board VGA, but all DVI solutions may have to be on add-in cards. Advantageously, some embodiments of the invention may provide the automatic capability for on board DVI while also supporting another high end add in card that the customer may decide to use.

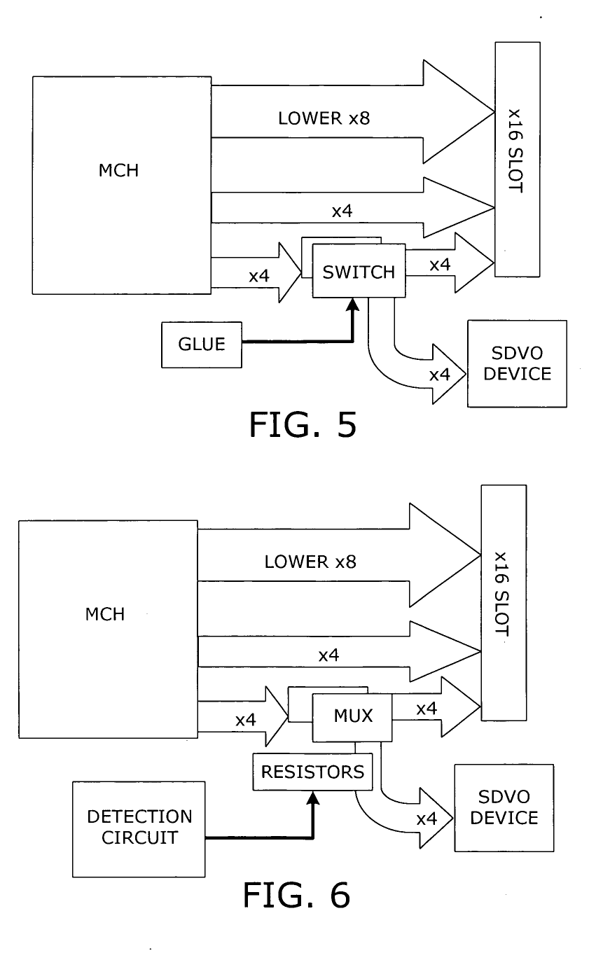

With reference to FIG. 5, some embodiments of the invention may include an expansion slot (e.g. an x16 PCIe slot) coupled to an MCH (or a GMCH) by a signal bus. A switch may be positioned between the MCH and the slot to direct some of the bus signals to either the slot (e.g. for expansion graphics) or to an SDVO device (e.g. for on board graphics). Glue logic may be provided to control the state of the switches (e.g. based on the type of card in the slot).

With reference to FIG. 6, the switches may be implemented with multiplexers (MUX). The glue logic may include a detection circuit and a set of pull-up resistors. For example, the system may be configured with various options which can be identified by populating or de-populating the resistors. For example, for various application the following options may be specified with resistor pop/depop option:
A) only PCI Express Graphics (PEG);
B) only SDVO;
C) always enable on-board video (DVI+VGA);
D) when any card plugged in, then switch off onboard capability.

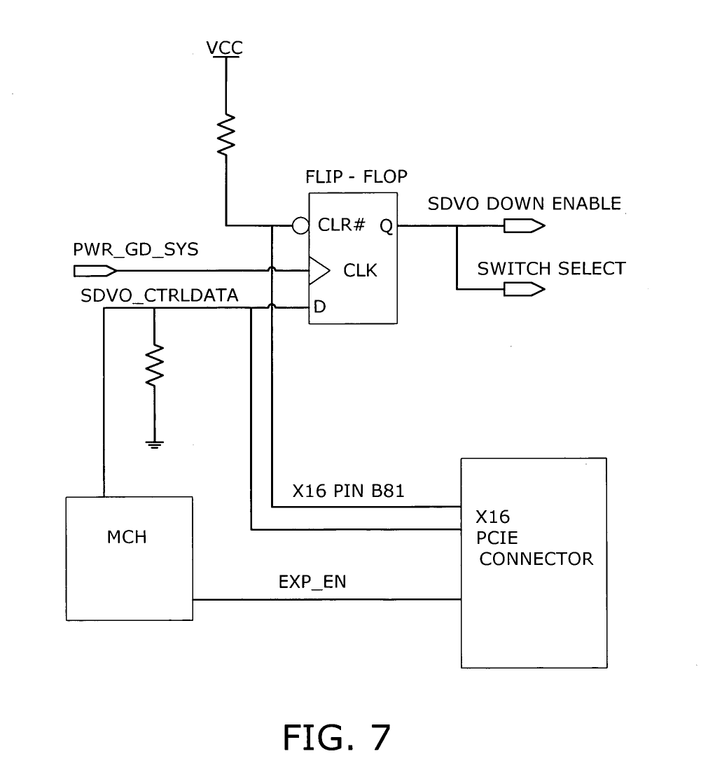

With reference to FIG. 7, another electronic system may include an x16 PCIe connector. An MCH may be coupled to the PCIe connector, including receiving signals corresponding to the B81 pin and the SDVO_CTRLDATA pin. A logic circuit includes a flip-flop having its CLR# pin connected to the B81 signal and its D pin connected to the SDVO_CTRLDATA signal. A weak pull-up is also connected to the CLR# pin. A weak pull down is connected to the D pin. The CLK pin of the flip-flop receives a signal corresponding to the system power good signal (PWR_GD_SYS). The Q output pin of the flip-flop is utilized as an enable signal for the onboard SDVO graphics (SDVO DOWN ENABLE) and also as a switch select signal (SWITCH SELECT) to select between directing graphics signals to the PCIe connector or to the on board graphics. The MCH may provide an expansion card enable signal (EXP_EN) to the PCIe connector (for example, MCH pin J17 also routed to x16 connector pin B48).

A system that has an SDVO device down solution on the motherboard and a PCI Express Graphics x16 expansion slot as well may be referred to as a 3 point display system. In some embodiments SDVO video mode may be the default, but populating the x16 slot with a graphics expansion card will disable the SDVO down, enable the x16 PCI Express Graphics card, and configure the system for PCIe Graphics. For example, some implementations may also support Add2 and MEC expansion cards.

In some embodiments of the invention, strap controlling logic and PCIe switches are added to the system. For example, the straps required may be sampled by discrete logic on the on the mother board. Before the assertion of PWR_OK to the MCH, this logic may detect if an add-in card is present in the x16 slot, drive the straps accordingly, and disable the SDVO down. During the assertion of PWR_OK to the MCH, the strap values are latched in and the part boots in the correct configuration. This logic may also generate the switch select signal for the correct steering of the data to the correct location (e.g. see FIGS. 5 and 8-9).

In some implementations, due to the electrical characteristics of the data signals involved and because PCIe and SDVO signals may be MUXed onto the same interface on MCH, switching logic may be required to steer the data in the correct fashion.

For example, some implementations may support the following graphics modes:

| Supported Video Mode | Possible Concurrent Video Mode |
|---|---|
| VGA | SDVO, PCIe Graphics |
| SDVO Down on Mother | VGA |
| board (single channel) | |
| SDVO via ADD2 | VGA |
| Expansion Card | |
| SDVO via MEC | VGA |
| Expansion Card | |
| x16 PCIe Graphics | VGA |

In conventional systems, the strapping was static, in that pull-ups or pull-downs on the motherboard or add-in cards forced the strap values to insure the correct video mode. A problem with static strapping is that the conventional system only allowed for one video method to be supported (e.g. either an on board solution, or the x16 PCIe graphics expansion slot, but not both).

Advantageously, in a 3 point display system in accordance with some embodiments of the invention, the straps may be determined from what video devices are detected in system (e.g. by discrete logic on the motherboard). For example, in some implementations, the PCI Express HotPlug detection methodology may be utilized to detect if a PCIe graphics card is in the x16 slot. The HotPlug detection methodology requires that PRSNT1# (pin A1) on the PCIe x16 connector be tied to ground.

With reference to FIG. 7, the strap pins and states before PWR_OK assertion in an example 3 Point Display System may be as follows:

| Video Device | B81 | SDVO_CTRLDATA | EXP_EN |
|---|---|---|---|
| SDVO Down | Float | Low | Low |
| ADD2 Expansion Card | Float | High | Low |
| MEC Expansion Card | Float | High | High |
| x16 PCIe Graphics Card | Low | Low | Low |

For example, in some implementations, SDVO_CTRLDATA may correspond to MCH pin G17 (also routed to x16 connector pin B31) and EXP_EN may correspond to MCH pin J17 (also routed to x16 connector pin B48). Without the PCIe x16 connector populated, pin B81 will float. It will only be pulled low if an x16 card is populated through the pin Al as per HotPlug guidelines. The SDVO_CTRLDATA signal may be used as a strap on the MCH for support of ADD2 and MEC expansion cards. For example, the PRSNT2# pin (x16 connector pin B31) may be used for card detection for ADD2 and MEC expansion cards. Advantageously, VGA can be supported in any configuration.

With reference to FIG. 7, the strap control logic has three inputs: Pin B81 from the x16 PCIe connector, SDVO_CTRLDATA from the MCH, and a signal that indicates a stable level of power in the system before the assertion of PWR_OK to the MCH. For this instance, this signal will be referred to as PWR_GD_SYS. For example, a target time of 100 ms between the PWR_GD_SYS signals and the PWR_OK signals should be sufficient to set the chipset straps.

The strap control circuit has two basic choices: enable graphics installed on the board, or enable graphics installed via an Add-in card. As such, only the strap signals x16 Pin B81 and SDVO_CTRLDATA are necessary to determine a card presence. However, they do need to be asserted into determined states. Therefore B81 uses a weak pull up to provide a high state, and SDVO_CTRLDATA uses a weak pull down. The states may be latched into a flip-flop at the assertion of PWR_GD_SYS as follows:

| | | | | SDVO |
|---|---|---|---|---|
| Video Device | B81 | SDVO_CTRLDATA | PWR_GD_SYS | Down Enable |
| SDVO Down | High | Low | Low to high | Low |
| ADD2 | High | High | Low to high | High |
| Expansion Card | | | | |
| MEC Expansion | High | High | Low to high | High |
| Card | | | | |
| x16 PCIe | Low | Low | X | High |
| Graphics Card | | | | |

In a system with an unpopulated x16 PCIe socket, the SDVO Down Enable signal is low. In this state, the SDVO down subsystem is allowed to come out of reset and be enabled via normal means. When the SDVO Down Enable signal is high (x16 slot populated), the platform reset is blocked from the SDVO down subsystem, holding it in a state of reset; allowing for the add-in card to power on normally. The strap control logic, while controlling the SDVO down subsystem, is also used as a switch select for the required PCIe switches. These switches steer the muxed signals of the SDVO/PCIe graphics interfaces to the proper place depending on configuration.

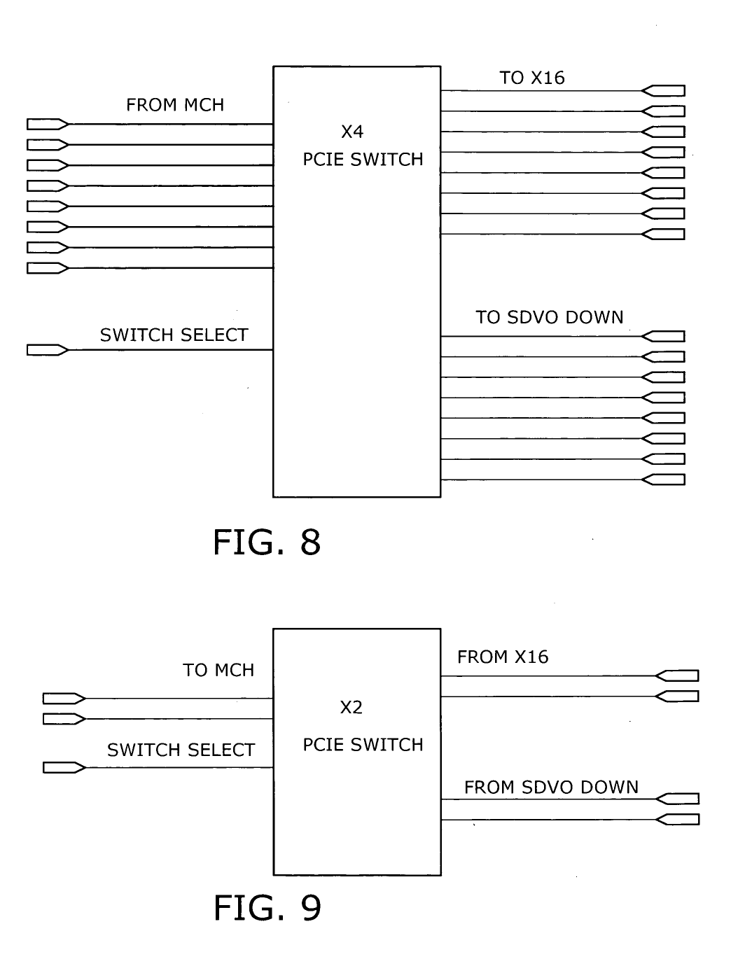

With reference to FIGS. 8 and 9, an example switching topology may take the signals required for a signal channel SDVO solution (e.g. channel B of the SDVO interface) and route them through two switches (e.g. an x4 PCIe switch in FIG. 8 and an x2 PCIe switch in FIG. 9, for a system design with PCIe lane reversal enabled on the MCH). For example, the switches may be controlled via the switch select signal regenerated from the strap detect logic described in connection with FIG. 7. When the switch select is low (SDVO Down Enable is low) the switches steer the signals to the SDVO down subsystem. When the switch select is high (SDVO Down Enable is high), the switches steer the signals to the x16 PCIe connector. For example, the x4 PCle switch may be utilized to connect the EXP_TX_P and EXP_TX_N signals (0 through 3) from the MCH to the corresponding signals on the x16 connector, or to connect the EXP_TX_P and EXP_TX_N signals (0 through 3) from the MCH to the SVDO_P and SVDO_N signals (R, G, B, and C) for the SDVO down subsystem. Likewise, the x2 PCIe switch may be utilized to connect the EXP_RX_P_1 and EXP_RX_N_1 signals from the x16 connector to the MCH, or to connect the SDVO_P_1 and SDVO_N_1 signals from the SDVO down subsystem to the MCH.

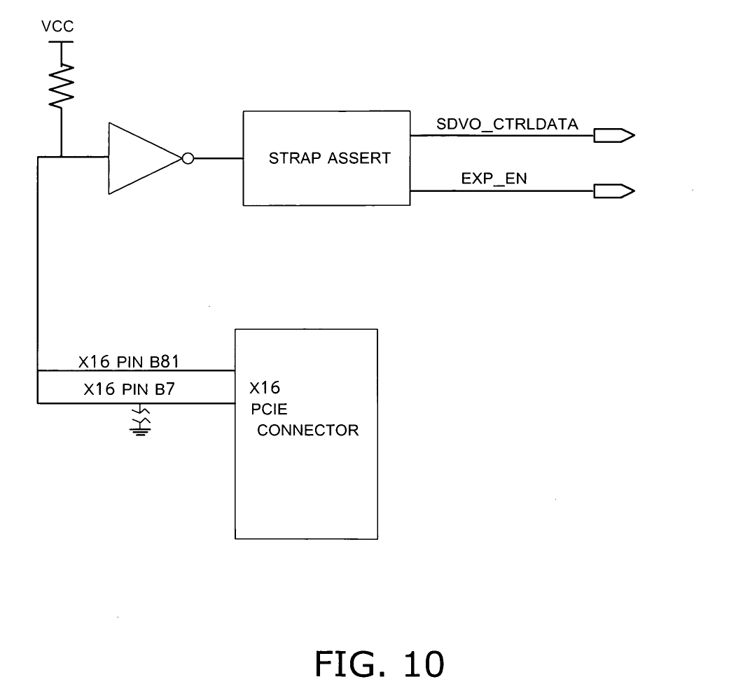

With reference to FIG. 10, another example strap control circuit provides a weak pull up “logic 1” on pin B81 of X16 slot, disconnects pin B7 of X16 slot from ground (e.g. on the motherboard), and ties pin B7 together with pin B81. Pin B81 logic “1” may be utilized to strap the SDVO_CTRLDATA & EXP_EN, in order to enable on board DVI. When there is any card presence detected in the X16 slot, pin B7 of the X16 slot will be pulling to ground, and hence pin B81 of the X16 slot will be GND as well, and provide a logic “0”, thereby disabling the on board DVI.

In particular, connecting both pin B81 and pin B7 of the X16 slot together and makes the combined signal become the B81 signal. On board, the B81 signal uses a weak pull up to provide a high state into an inverter when there is no card present in the X16 slot. The output of the inverter then provides a low state and toggles transistor circuits that assert the necessary straps to enable SDVO for the onboard DVI solution.

When any card (e.g. a graphics card) is inserted into the X16 slot, the B81 signal will be a low state, and hence toggles the inverter and transistor circuit to de-assert the necessary straps to disable the onboard DVI solution. An example state table follows:

| | Combined B81 | DVI | SDVO_CTRLDATA | EXP_EN |
|---|---|---|---|---|
| No Card | High | Enable | High | High |
| ADD2-N | Low | Disable | High | Low |
| MEC | Low | Disable | High | High |
| PEG, X16 | Low | Disable | Low | Low |
| PCIe X8 | Low | Disable | Low | Low |
| PCIe X4 | Low | Disable | Low | Low |
| PCIe X1 | Low | Disable | Low | Low |

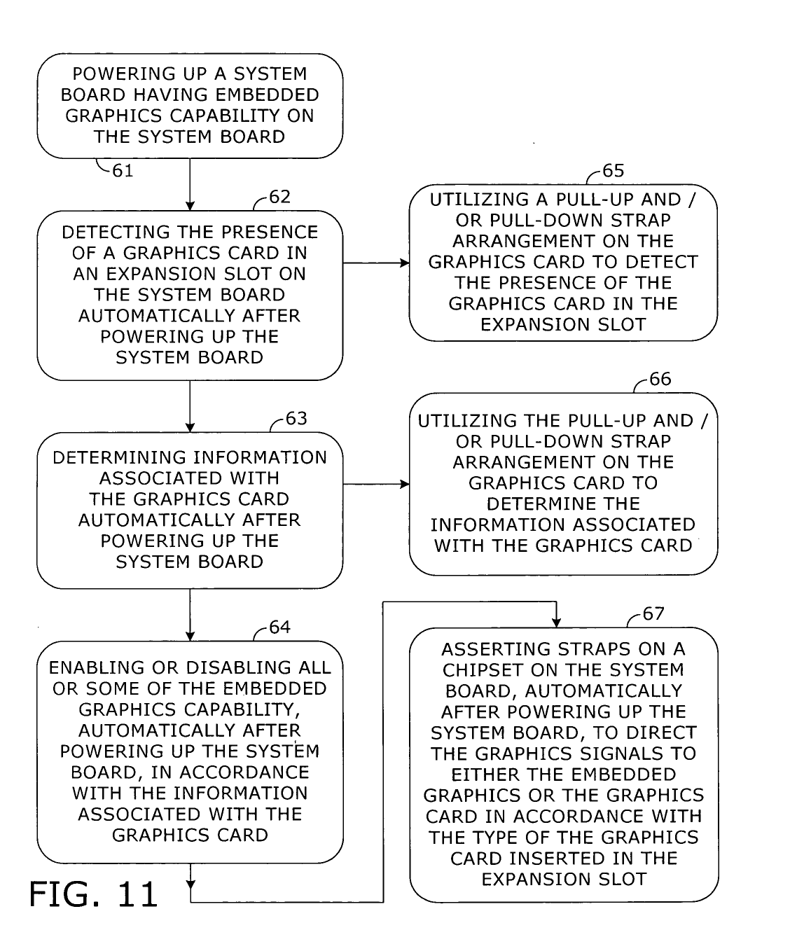

With reference to FIG. 11, some embodiments of the invention involve powering up a system board having embedded graphics capability on the system board (e.g. at block 61), detecting the presence of a graphics card in an expansion slot on the system board automatically after powering up the system board (e.g. at block 62), determining information associated with the graphics card automatically after powering up the system board (e.g. at block 63), and enabling or disabling all or some of the embedded graphics capability, automatically after powering up the system board, in accordance with the information associated with the graphics card (e.g. at block 64).

For example, the graphics card may include a digital video interface capability. For example, enabling or disabling all or some of the embedded graphics capability may include enabling or disabling an embedded digital video interface capability. For example, the information associated with the graphics card includes a type of the graphics card.

In some embodiments of the invention, detecting the presence of a graphics card may include utilizing a pull-up and/or pull-down strap arrangement on the graphics card to detect the presence of the graphics card in the expansion slot (e.g. at block 65). For example, determining information associated with the graphics card may include utilizing the pull-up and/or pull-down strap arrangement on the graphics card to determine the information associated with the graphics card (e.g. at block 66).

For example, the information associated with the graphics card may include a type of the graphics card inserted in the expansion slot. In some embodiments of the invention, enabling or disabling all or some of the embedded graphics capability may include asserting straps on a chipset on the system board, automatically after powering up the system board, to direct the graphics signals to either the embedded graphics or the graphics card in accordance with the type of the graphics card inserted in the expansion slot (e.g. at block 67).

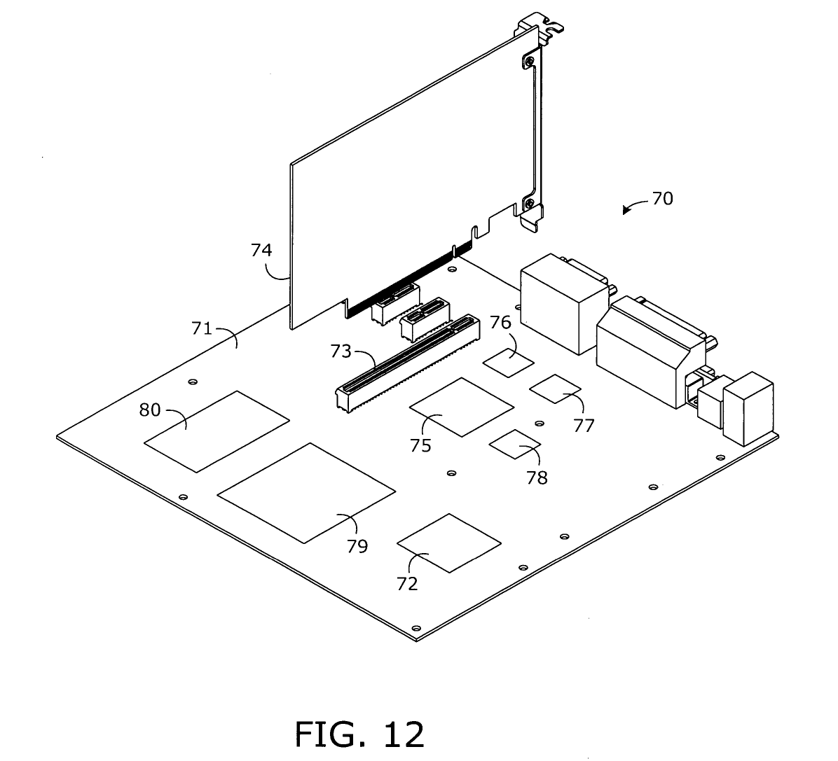

With reference to FIG. 12, an electronic system 70 may include a system board 71 having embedded graphics capability 72 on the system board 71. The system 70 may include an expansion slot 73 on the system board 71 adapted to receive an add-in card (e.g. a graphics card 74). The system 70 may further include a chipset 75 on the system board 71 for directing graphics signals to either the embedded graphics 72 or the expansion slot 73. According to some embodiments of the invention, a first circuit 76 on the system board 71 may be configured to detect the presence of the graphics card 74 in the expansion slot 73 automatically after powering up the system board 71. A second circuit 77 on the system board 71 may be configured to determine information associated with the graphics card 74 automatically after powering up the system board 71. A third circuit 78 on the system board 71 may be configured to utilize the information associated with the graphics card 74 to enable or disable all or some of the embedded graphics capability 72 automatically after powering up the system board 71.

For example, the graphics card 74 may include a digital video interface capability. For example, the third circuit 78 may be configured to enable or disable an embedded digital video interface capability. For example, the information associated with the graphics card 74 includes a type of the graphics card 74.

In some embodiments of the system 70, the first circuit 76 may be configured to utilize a pull-up and/or pull-down strap arrangement on the graphics card 74 to detect the presence of the graphics card 74 in the expansion slot 73. Likewise, the second circuit 77 may be configured to utilize the pull-up and/or pull-down strap arrangement on the graphics card 74 to determine the information associated with the graphics card 74. For example, the information associated with the graphics card 74 may include a type of the graphics card 74 inserted in the expansion slot.

In some embodiments of the system 70, the third circuit 78 may be configured to assert straps on the chipset 75, automatically after powering up the system board 71, to direct the graphics signals to either the embedded graphics 72 or the expansion slot 73 in accordance with the type of the graphics card 74 inserted in the expansion slot 73. The system 70 may include additional electronic components on the system board 71 such as, for example, a processor 79 and a memory subsystem 80 (e.g. a bank of double data rate memory coupled to the system board 71).

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. An apparatus, comprising:
a system board having embedded graphics capability on the system board;
an expansion slot on the system board adapted to receive an add-in card;
a first circuit on the system board to detect the presence of a graphics card in the expansion slot automatically after powering up the system board;
a second circuit on the system board to determine information associated with the graphics card automatically after powering up the system board; and
a third circuit on the system board configured to utilize the information associated with the graphics card to enable or disable all or some of the embedded graphics capability automatically after powering up the system board.

2. The apparatus of claim 1, wherein the graphics card comprises a digital video interface capability.

3. The apparatus of claim 2, wherein the third circuit is configured to enable or disable an embedded digital video interface capability.

4. The apparatus of claim 1, wherein the information associated with the graphics card includes a type of the graphics card.

5. The apparatus of claim 1, wherein the first circuit is configured to utilize a pull-up and/or pull-down strap arrangement on the graphics card to detect the presence of the graphics card in the expansion slot.

6. The apparatus of claim 5, wherein the second circuit is configured to utilize the pull-up and/or pull-down strap arrangement on the graphics card to determine the information associated with the graphics card.

7. The apparatus of claim 6, wherein the information associated with the graphics card includes a type of the graphics card inserted in the expansion slot.

8. The apparatus of claim 7, further comprising:
a chipset on the system board for directing graphics signals,
wherein the third circuit is configured to assert straps on the chipset, automatically after powering up the system board, to direct the graphics signals to either the embedded graphics or the graphics card in accordance with the type of the graphics card inserted in the expansion slot.

9. A method, comprising:
powering up a system board having embedded graphics capability on the system board;
detecting the presence of a graphics card in an expansion slot on the system board automatically after powering up the system board;
determining information associated with the graphics card automatically after powering up the system board; and
enabling or disabling all or some of the embedded graphics capability, automatically after powering up the system board, in accordance with the information associated with the graphics card.

10. The method of claim 9, wherein the graphics card comprises a digital video interface capability.

11. The method of claim 10, wherein enabling or disabling all or some of the embedded graphics capability includes enabling or disabling an embedded digital video interface capability.

12. The method of claim 9, wherein the information associated with the graphics card includes a type of the graphics card.

13. The method of claim 9, wherein detecting the presence of a graphics card includes utilizing a pull-up and/or pull-down strap arrangement on the graphics card to detect the presence of the graphics card in the expansion slot.

14. The method of claim 13, wherein determining information associated with the graphics card includes utilizing the pull-up and/or pull-down strap arrangement on the graphics card to determine the information associated with the graphics card.

15. The method of claim 14, wherein the information associated with the graphics card includes a type of the graphics card inserted in the expansion slot.

16. The method of claim 15, wherein enabling or disabling all or some of the embedded graphics capability includes asserting straps on a chipset on the system board, automatically after powering up the system board, to direct the graphics signals to either the embedded graphics or the graphics card in accordance with the type of the graphics card inserted in the expansion slot.

17. A system, comprising:
a system board having embedded graphics capability on the system board;
an expansion slot on the system board adapted to receive an add-in card;
a chipset on the system board for directing graphics signals to either the embedded graphics or the expansion slot;
a first circuit on the system board to detect the presence of a graphics card in the expansion slot automatically after powering up the system board;
a second circuit on the system board to determine information associated with the graphics card automatically after powering up the system board; and
a third circuit on the system board configured to utilize the information associated with the graphics card to enable or disable all or some of the embedded graphics capability automatically after powering up the system board.

18. The system of claim 17, wherein the graphics card comprises a digital video interface capability.

19. The system of claim 18, wherein the third circuit is configured to enable or disable an embedded digital video interface capability.

20. The system of claim 17, wherein the information associated with the graphics card includes a type of the graphics card.

21. The system of claim 17, wherein the first circuit is configured to utilize a pull-up and/or pull-down strap arrangement on the graphics card to detect the presence of the graphics card in the expansion slot.

22. The system of claim 21, wherein the second circuit is configured to utilize the pull-up and/or pull-down strap arrangement on the graphics card to determine the information associated with the graphics card.

23. The system of claim 22, wherein the information associated with the graphics card includes a type of the graphics card inserted in the expansion slot.

24. The system of claim 23, wherein the third circuit is configured to assert straps on the chipset, automatically after powering up the system board, to direct the graphics signals to either the embedded graphics or the expansion slot in accordance with the type of the graphics card inserted in the expansion slot.

25. The system of claim 17, further comprising:
a processor on the system board.

26. The system of claim 25, further comprising:
a double data rate memory coupled to the system board.
